(19) United States
(12) Patent Application Publication
(10) Pub. No.: US 2006/0232816 A1
(43) Pub. Date: Oct. 19, 2006

(54) Image processing apparatus, method for updating control program, and program

(75) Inventor: Shigeki Konno, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: Canon Kabushiki Kaisha, Ohta-ku (JP)

(21) Appl. No.: 11/399,995

(22) Filed: Apr. 7, 2006

(30) Foreign Application Priority Data
Apr. 14, 2005 (JP) 2005-116538

(51) Int. Cl. G06F 3/12

(52) U.S. Cl. 358/1.15; 358/1.13

(57) ABSTRACT

An image processing apparatus for performing an image processing operation based on execution of a control program includes a receiving unit configured to receive an updating control program, an updating unit configured to update the control program to the updating control program, and a control unit configured to inhibit the updating unit from updating the control program to the updating control program when it is determined that the updating of the control program to the updating control program by the updating unit causes loss of set information of the image processing apparatus referred to by the control program.

### BACKGROUND OF THE INVENTION

1. Field of the Invention

The present invention relates to an image processing apparatus capable of updating a control program for controlling image processing, a method for updating the control program, and a program.

2. Description of the Related Art

There has conventionally been proposed an image processing apparatus capable of adding functions or correcting faults by version-upgrading of a control program, firmware or the like. For example, the following work could be carried out when the version of the control program is upgraded:

(1) Back-up of information set in the image processing apparatus, such as user data (e.g., information of options regarding paper feeding, information such as information of the image processing apparatus set by user) or image management data (management information or the like regarding image data stored in the image processing apparatus) in the image processing apparatus;

(2) Downloading of updating control program in the image processing apparatus;

(3) Initialization of a system by the updating control program; and

(4) Restoring of user data.

Depending on an image processing apparatus, all the aforementioned operations (1) to (4) must be carried out in predetermined order after execution of a printing job or setting of a special state for inhibiting an operation performed by a general user.

Moreover, in order to meet a demand for shortening down-time of the image processing apparatus, an apparatus has been proposed to permit execution of the aforementioned operations (1) and (2) during general user's operation or a system operation in which a printing job can be executed. It has also been proposed to execute the operation (3) by restarting the image processing apparatus.

According to such an apparatus, in order to improve maintenance of the apparatus, the operations (1) to (4) can be executed in user's optional timing (e.g., Japanese Patent Application Laid-Open No. 11-282655). However, when the user does not recognize the necessity of the back-up operation (1), and when an order of the back-up operation (1) and the download operation (2) are not defined, the user may restart the system without performing the back-up operation (1) after the end of the download operation (2) and initialize the system (3).

When there is no compatibility with respect to management structure of user data or image management data in the apparatus between the updating control program and a previous control program, this data may be deleted by the system initialization. Besides, there is a disadvantage in that it becomes impossible to restore the user data or the image management data since the back-up operation (1) is not carried out.

### SUMMARY OF THE INVENTION

The present invention is provided as a response to the aforementioned disadvantages of the conventional art. For example, according to an image processing apparatus and a control program updating method of the present invention, it is possible to prevent loss of set information of the apparatus such as user data or image management data.

According to a first exemplary embodiment of the present invention, an image processing apparatus includes a receiving unit configured to receive an updating control program, an updating unit configured to update a control program to the updating control program, and a control unit configured to inhibit the updating unit from updating the control program to the updating control program when it is determined that the updating of the control program to the updating control program by the updating unit causes loss of set information of the image processing apparatus referred to by the control program.

According to another exemplary embodiment of the present invention, an image processing apparatus includes a storing unit configured to store an updating control program received from the outside, a determining unit configured to determine whether loss of set information of the image processing apparatus referred to by the control program is caused by updating of the control program to the updating control program stored in the storing unit, and a deciding unit configured to decide whether to update the control program to the updating control program stored in the storing unit based on determination of the determining unit.

According to another exemplary embodiment of the present invention, an image processing apparatus includes a storing unit configured to store the control program and an updating control program, a determining unit configured to determine whether loss of set information of the image processing apparatus referred to by the control program is caused by updating of the control program to the updating control program, and a selecting unit configured to selectively execute one of the control program and the updating control program based on a determining result of the determining unit when the updating control program is stored in the storing unit.

According to yet another exemplary embodiment of the present invention, a method for updating a control program in an image processing apparatus includes a receiving step of receiving an updating control program, an updating step of updating the control program to the updating control program, and a control step of inhibiting the updating step from updating the control program to the updating control program when it is determined that the updating of the control program to the updating control program in the updating step causes loss of set information of the image processing apparatus referred to by the control program.

According to yet another exemplary embodiment of the present invention, a method for updating a control program in an image processing apparatus includes a storing step of storing an updating control program received from the outside in a storing unit, a determining step of determining whether loss of set information of the image processing apparatus referred to by the control program is caused by updating of the control program to the updating control program stored in the storing unit, and a deciding step of deciding whether to update of the control program to the updating control program stored in the storing unit based on a determining result of the determining step.

According to still another exemplary embodiment of the present invention, a method for updating a control program in an image processing apparatus which includes a storing unit configured to store the control program and an updating control program and performs an image processing operation based on execution of a control program includes a determining step of determining whether loss of set information of the image processing apparatus referred to by the control program is caused by updating of the control program to the updating control program, and a selecting step of selectively executing one of the control program and the updating control program based on a determining result of the determining step when the updating control program is stored in the storing unit.

And, according to still yet another exemplary embodiment of the present invention, a computer program is provided which causes a computer to execute the method for updating the control program.

### BRIEF DESCRIPTION OF THE DRAWINGS

The accompanying drawings, which are incorporated in and constitute a part of the specification, illustrate exemplary numerous embodiments, features and aspects of the invention and, together with the description serve to explain the principles of the invention.

FIG. 1 is a block diagram showing an example of an image processing apparatus according to a first exemplary embodiment of the present invention.

FIG. 2 is a sectional diagram showing the image processing apparatus of FIG. 1 in detail.

FIG. 3 is a block diagram showing an exemplary controller of FIG. 1 in detail.

FIG. 4 is a diagram showing an organizational structure of a control program executed in the controller of FIG. 1.

FIG. 5 is a diagram showing a module structure of a job control unit of FIG. 4.

FIG. 6 is a diagram showing a concept of a management structure of a document management unit shown in FIG. 4.

FIG. 7 is a diagram showing a configuration of a code data rasterizing and storing job which is one of the jobs executed by the controller of FIG. 1.

FIG. 8 is a diagram showing an exemplary configuration of a stored image printing job which is one of the jobs executed by the controller of FIG. 1.

FIG. 9 is a diagram showing an exemplary configuration of a code data printing job which is one of the jobs executed by the controller of FIG. 1.

FIG. 10 is a diagram showing an exemplary directory structure built by using a file system of an HDD of FIG. 1.

FIG. 11 is a diagram showing an example of a memory map by a CPU of FIG. 1.

FIG. 12 is a flowchart showing an example of a first data processing procedure in the image processing apparatus of the exemplary embodiment.

FIG. 13 is a flowchart showing an example of a second data processing procedure in the image processing apparatus of FIG. 1.

FIG. 14 is a diagram showing a memory map of a storage medium for storing various data processing programs read by the image processing apparatus of the exemplary embodiment.

### DETAILED DESCRIPTION OF THE EXEMPLARY EMBODIMENTS

Exemplary embodiments, features and aspects of the present invention will now herein be described in detail below in accordance with the accompanying drawings.

### First Exemplary Embodiment

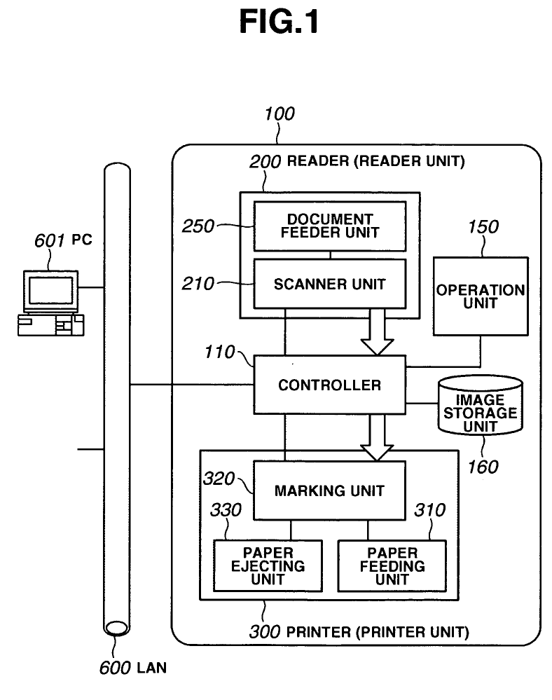

FIG. 1 is a diagram showing an example of a system which includes an image processing apparatus according to a first exemplary embodiment of the present invention. In the drawing, a digital multi-function peripheral 100 serving as the image processing apparatus and a client PC 601 are connected to communicate with each other through an LAN 600 as an example.

Referring to FIG. 1, the client PC 601 is a computer in which a general-purpose OS such as Microsoft Windows (registered trademark) or UNIX (registered trademark) is operated. Application software of a word processor for creating print data, and a printer driver started by the application software are used for job entry to the multi-function peripheral. The client PC 601 includes hardware such as a display which is an output device, a controller board (including CPU, RAM, ROM, and the like), a hard disk, a pointing device or a keyboard which is an input device, and the like, and it is configured to execute various applications.

In the client PC 601, an application for transferring an updating control program to the digital multi-function peripheral updates a control program of the digital multi-function peripheral 100. As the application, for example, a client application of a file transfer protocol (FTP) is available.

The digital multi-function peripheral 100 includes a reader 200 for reading a document image to generate image data, a printer 300 for recording the image data in a recording sheet, an operation unit 150 equipped with a liquid crystal panel and a keyboard for displaying the image data or displaying/setting various functions, an image storage unit 160 for storing image data read by controlling the reader 200 or image data generated based on code data (PDL data or compressed image data) received from the client PC 601 or another digital multi-function peripheral through the LAN 600, and a controller 110 connected to these components to control them.

The reader 200 includes a document feeder unit 250 for conveying a document sheet to a platen glass, and a scanner unit 210 equipped with a CCD or the like to optically read and convert the document image into image data which is an electric signal.

The printer 300 includes a paper feeding unit 310 equipped with a plurality of paper feeding cassettes to store recording sheets, a marking unit 320 for transferring/fixing image data to a recording sheet, and a paper ejection unit 330 for ejecting the sheet to the outside after subjecting the printed recording sheet to sort processing or stapling processing.

The controller 110 includes a network I/F for communication through the LAN 600, and has a communication function of processing various network protocols. By the communication function, code data (PDL data or compressed image data) or a control command is received from the client PC 601 or another digital multi-function peripheral, and the aforementioned components are controlled, so that complex function processing including a copying function, a code data (PDL) printing function, an image storing function, a stored image printing function, and the like are realized.

As one of the communication functions, an updating control program for the digital multi-function peripheral 100 is received from the client PC 601 and stored in the image storage unit 160. The image storage unit 160 is managed by a file system such as an FAT, and a server function of an FTP, for example, is performed.

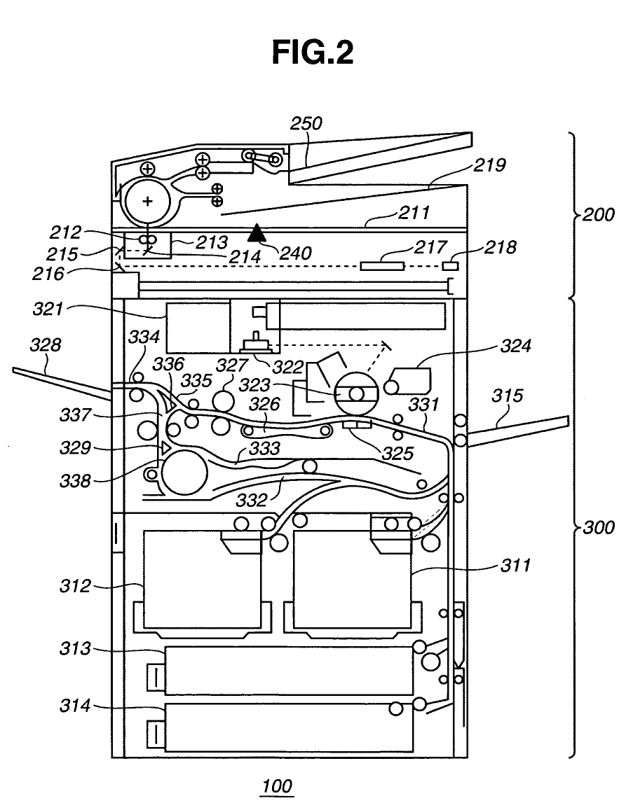

FIG. 2 is a sectional diagram showing the digital multi-function peripheral 100 of FIG. 1 in detail. The reader 200 feeds the document sheets loaded on the document feeder unit 250 one by one from a front sheet to the platen glass 211 in accordance with a loading order. The sheets are ejected to a paper ejection tray 219 after a predetermined operation of the scanner unit 210 is finished.

The scanner unit 210 lights a lamp 212 when the document sheets are conveyed to the platen glass 211 during the reading operation, and starts a movement of an optical unit 213 to scan the document sheets with a light from the lower side. A reflected light from the document sheets by the light emitted from the lamp 212 is guided through a plurality of mirrors 214 to 216 and a lens 217 to a CCD (charge coupled devices) image sensor (hereinafter “CCD”) 218, and the scanned document sheets are read by the CCD 218.

Then, the image data read by the CCD 218 is subjected to predetermined processing, and transferred to the controller unit 110. When the document feeder unit 250 has a document skimming-through function, the document sheets loaded on the document feeder unit 250 pass through a document skimming-through position 240 at a fixed speed. In this case, the optical unit 213 irradiates documents moved to the document skimming-through position 240 with a light from the lamp 212. The documents are being conveyed at equal speeds. The reflected light by the document is timely read by the CCD 218 to generate image data. The data is subjected to predetermined processing and transferred to the controller unit 110.

The printer 300 generates a laser beam corresponding to the image data output from the controller 110. The laser beam is emitted from a laser emission unit 322 driven by a laser driver 321. An electrostatic latent image is formed according to the laser beam on a photosensitive drum 323 which receives the laser beam. Then, a developer sticks to the electrostatic latent image in a developing device 324. In timing synchronized with the start of application of the laser beam, the recording sheet is fed from one of the cassettes 311 to 314 and a manual feeding tray 315, and conveyed through a paper path 331 to a transfer unit 325.

When the developer attached to the photosensitive drum 323 is transferred to the recording sheet in the transfer unit 325, the recording sheet having the image data transferred thereto is conveyed through a conveyor belt 326 to a fixing unit 327, and the image data is fixed on the recording sheet by heating/pressuring in the fixing unit 327. The recording sheet on which the data has been fixed is passed through paper paths 335 and 334 and ejected to a paper ejection pin 328. Then, when a printing surface is reversed and the sheet is ejected to the paper ejection pin 328, the sheet is guided to paper paths 336 and 338. The recording sheet is conveyed in an opposite direction therefrom, and passed through the paper paths 337 and 334 to be ejected to the paper ejection pin 328.

When the image data is recorded on both surfaces of the recording sheet, the recording sheet is passed through the fixing unit 327 from the paper path 336 to the paper path 333 by a flapper 329. Then the recording sheet is conveyed in an opposite direction to be guided to the paper path 338 and a refeeding paper path 332 by the flapper 329. Then, when the data is transferred and fixed again on the recording sheet that is guided to the refeeding paper path 332, the sheet is conveyed through the paper path 331 to the transfer unit 325, and processes similar to the above are performed thereafter.

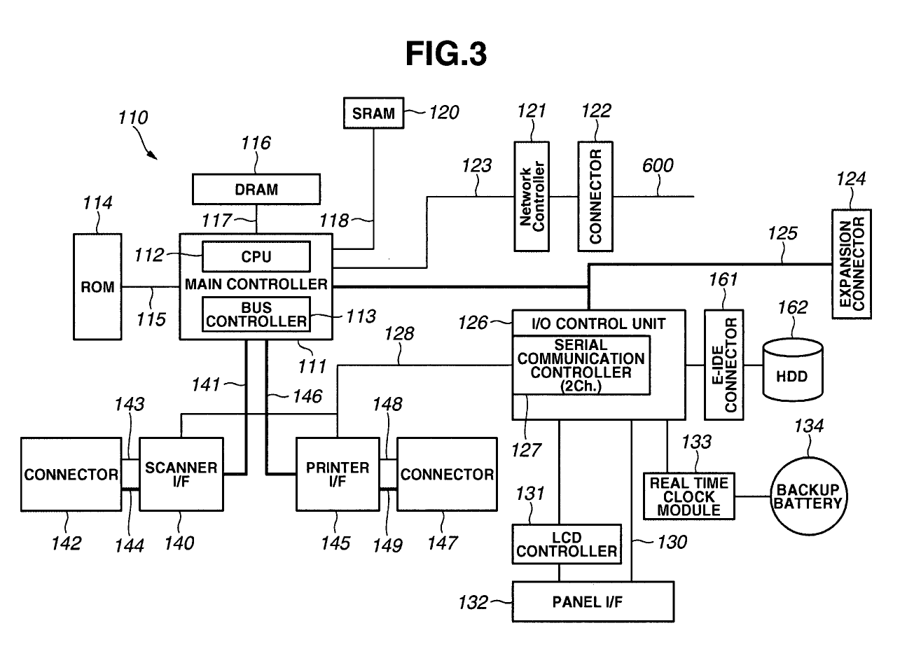

FIG. 3 is a block diagram showing the controller 110 of FIG. 1 in detail. A main controller 111 incorporates function blocks which include a CPU 112, a bus controller 113, and various controller circuits described below. The main controller 111 is connected to an ROM 114 through an ROM I/F 115, to a DRAM 116 through a DRAM I/F 117, to an SRAM 120 through an I/F 118, and to a network controller 121 through a network I/F 123, and performs a predetermined control operation communicating with the LAN 600 through a connector 122. As a network, Ethernet (registered trademark) is generally taken.

The ROM 114 stores various control programs or calculation data executed by the CPU 112 of the main controller 111. As one of the control programs, a boot code for loading a control program stored in an HDD 162 is stored on the DRAM 116. The boot code is executed at the time of starting the system. The DRAM 116 is used as a storage area of the control program that is executed by the CPU 112, its work area, and a storage area of image data. The SRAM 120 is used as an area for storing data that is kept even during power-OFF. Such data include user data described below or management data (image management data described below) of the image data stored in the HDD 162.

The main controller 111 is connected to a scanner I/F 140 through a scanner bus 141, to a printer I/F 145 through a printer bus 146, and to an expansion connector 124 via an expansion bus 125 to which an expansion board and an input/output control unit (I/O control unit) 126 are connected through a general-purpose high-speed bus such as a PCI bus. The I/O control unit 126 includes a 2-channel asynchronous serial communication controller 127 for transferring a control command to and from the reader 200 or the printer 300. The serial communication controller 127 is connected to the scanner I/F 140 and the printer I/F 145 through an I/O bus 128.

The scanner I/F 140 is connected to a scanner connector 142 through a first asynchronous serial I/F 143 and a first video I/F 144, and the scanner connector 142 is connected to a scanner unit 210 of the reader 200. The scanner I/F 140 executes binarization processing, and variable magnification processing in a main scanning direction and/or a subscanning direction, generates a control signal based on a video signal sent from the scanner unit 210, and transfers the image data to the main controller 111 through the scanner bus 141. The printer I/F 145 is connected to a printer connector 147 through a second asynchronous serial I/F 148 and a second video I/F 149, and the printer connector 147 is connected to a marking unit 320 of the printer 300.

The printer I/F 145 executes smoothing for the image data output from the main controller 111 to output the image data to the marking unit 320, and outputs a generated control signal to a printer bus 146. The control signal is generated based on a video signal sent from the marking unit 320. The bus controller 113 controls data transfer input/output from an external device connected to the scanner I/F 140, the printer I/F 145, the expansion connector 124 and the like. The bus controller 113 performs arbitration or controls DMA data transfer at the time of bus competition. That is, for example, data transfer from the scanner unit 210 to the DRAM 116, data transfer from the DRAM 116 to the marking unit 320, and the like are controlled by a bus controller 113 and transferred by DMA.

The I/O control unit 126 is connected to a panel I/F 132 through an LCD controller 131 and a key input I/F 130. The panel I/F 132 is connected to an operation unit 150. The I/O control unit 126 is connected to a real-time clock module 133 for updating/storing a date and time managed in the device. Also a backup battery 134 is provided for the clock module 133. The I/O control unit 126 is connected to a hard disk drive (HDD) 162 capable of writing/reading the control program or the image data through an E-IDE connector 161. The HDD 162 corresponds to the image storage unit 160 of FIG. 1.

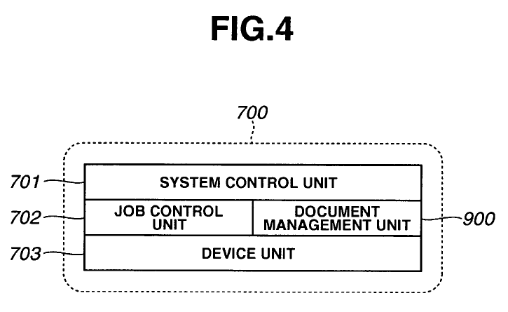

Next, referring to FIGS. 4 to 9, exemplary software processing will be described in a case where various jobs are processed in the digital multi-function peripheral 100.

FIG. 4 shows an exemplary organizational structure of a control program 700 executed by the controller 110 of FIG. 1. The control program 700 includes a system control unit 701, a job control unit 702, a device unit 703, and a document management unit 900. The system control unit 701 interprets a command sent from the client PC 601, another digital multi-function peripheral, or the operation unit 150 shown in FIG. 1 through each interface. The system control unit 701 requests the job control unit 702 to execute jobs, and realizes a copy function, a code data (PDL) printing function, an image storage function, a stored image printing function or the like.

The system control unit 701 has an FTP server function to receive an updating control program (including image processing program or the like) from the client PC 601 by downloading or the like during the operation of the digital multi-function peripherale 100. The job control unit 702 executes various jobs based on a request from the system control unit 701. The device unit 703 includes driver software for controlling each unit constituting the digital multi-function peripheral 100, and is operated when the job control unit 702 executes a job.

The document management unit 900 has a function of controlling the image storage unit 160 to manage the image data in a hierarchical manner, and is used by the system control unit 701 or the job control unit 702. A box area of each user is secured in the image storage unit 160, where jobs from the users are stored. After authentication processing is performed in the operation unit 150 or the like, the stored jobs can be directly subjected to image processing or in accordance with conditions set from the operation unit 150.

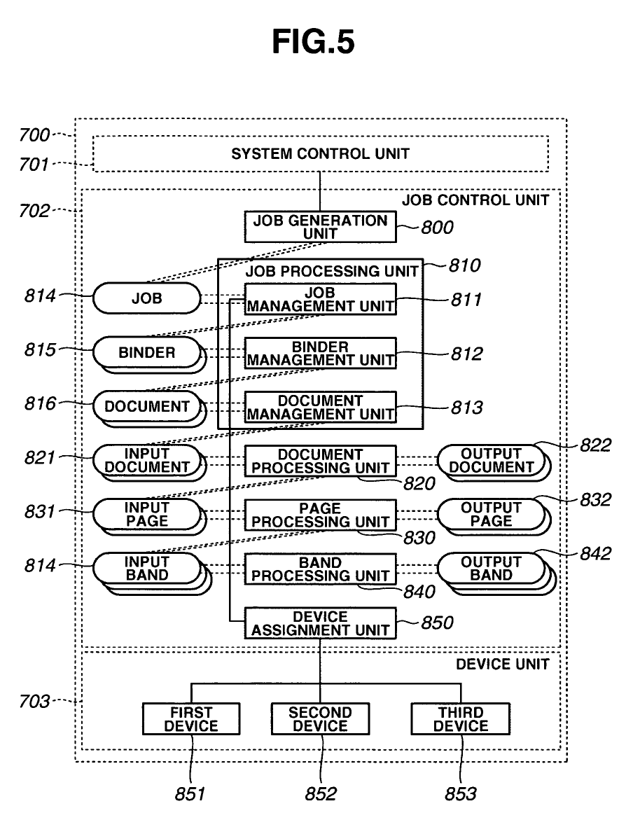

FIG. 5 shows an exemplary module structure of the job control unit 702 of FIG. 4. Reference numeral 700 denotes a control program, reference numeral 701 denotes a system control unit, reference numeral 702 denotes a job control unit, and reference numeral 703 denotes a device unit, which are identical to those shown in FIG. 4.

The job control unit 702 includes a job generation unit 800, a job processing unit 810, a document processing unit 820, a page processing unit 830, a band processing unit 840, and a device assignment unit 850. The job processing unit 810 includes a job management unit 811, a binder management unit 812, and a document management unit 813. The device unit 703 can include a plurality of devices such as a first device 851, a second device 852, and a third device 853.

A series of operation requests sent from the client PC 601, the operation unit 150 or the like are sent in forms of commands (protocols) through each interface. The commands that have been sent are interpreted by the system control unit 701, and then sent to the job control unit 702. At this stage, the commands are converted into forms that can be understood by the job control unit 702.

The job generation unit 800 generates jobs 814. The jobs 814 are a copy job, a read image storing job, a code data printing job, a code data rasterizing and storing job, a stored image printing job, and the like. By combining these jobs, the system control unit 701 realizes a copy function, a code data (PDL) printing function, an image storing function, a stored image printing function, and the like. The commands (protocol) interpreted and converted by the system control unit 701 contain various pieces of set information such as a document name, the number of prints at the time of printing, and a type/feeding cassette of a recording sheet, and code data (PDL data or compressed image data), e.g., in the case of the code data rasterizing and storing job.

The job 814 is sent to the job processing unit 810 and processed. The job processing unit 810 includes a job management unit 811, a binder management unit 812, and a document management unit 813. In the job management unit 811, setting of the entire job such as output order of a plurality of binders that constitutes the job is executed. In the binder management unit 812, setting of the entire binder such as output order of a plurality of documents constituting the binder is executed. In the document management unit 813, setting of the entire document such as output order of a plurality of pages constituting the document is executed. Thus, the job processing unit 810 executes setting and processing regarding all the jobs 814.

The job processing unit 810 divides the job into binders 815 which are smaller work units constituting the job 814 except the setting regarding the entire job 814. Further, the job processing unit 810 divides the binder 815 into documents 816 which are smaller work units constituting the binder 816 except the setting regarding the entire binder 815 and processes the documents. The documents 816 correspond to input documents 821 one to one. Each input document 821 is converted into an output document 822 by the document processing unit 820.

For example, in the case where the scanner unit 210 performs a scanning job to read a bundle of documents and convert them into a plurality of image data, setting regarding the bundle of documents and an operation procedure are written in the input document 821, and setting regarding the plurality of image data and an operation procedure are written in the output document 822. It is the document processing unit 820 that converts the bundle of sheets into a plurality of image data.

The document processing unit 820 converts a document unit from the input document 821 into the output document 822, divides the document into input pages 831 which are smaller work units except setting and processing regarding the entire document, and requests the page processing unit 830 to perform the processing. This is similar to a case where the job processing unit 810 devotes itself to processing of a job unit and generates a binder 815 and a document 816 for more meticulous work.

The setting and the operation of a document unit specifically concerns page order such as rearrangement of pages, designation of both-surface printing, addition of a front cover, and insertion of OHP. The page processing unit 830 converts a page unit from an input page 831 to an output page 832. For example, in the case of the scanning job, various settings such as reading resolution and a reading direction (landscape/portrait) and procedures for them are written in the input page 831, and setting such as an image data storing place and procedures for them are written in the output page 832.

Further, in the case of processing the job 814 by a memory of several lines (band memory), a page is divided into bands which are smaller units and conversion is performed on them. Operations of an input band 841, a band processing unit 840, and an output band 842 are similar to those in the case of the page. The job processing unit 810, the document processing unit 820, the page processing unit 830, and the band processing unit 840 all use various physical devices which constitute the digital multi-function peripheral 100 when the processing is carried out.

Since simultaneous pursuit of work by the plurality of processing units causes device competition, the device assignment unit 850 arbitrates them. First to third devices 851 to 853 shown as examples are logical devices assigned to the above processing units by the device assignment unit 850. For example, a page memory, a band memory, the document feeder unit 250, an engine of the marking unit 320, the scanner unit 210, and the like are conceivable for such devices.

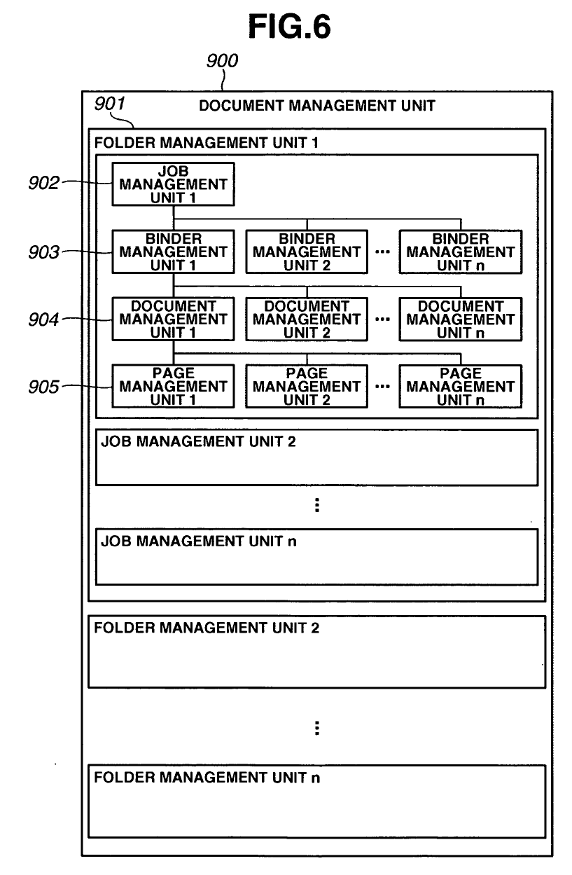

FIG. 6 shows a concept of an exemplary management structure of the document management unit 900 of FIG. 4. The document management unit 900 includes a folder management unit 901, a job management unit 902, a binder management unit 903, a document management unit 904, and a page management unit 905. Each unit has management information necessary for processing in the document management unit 900, and processing information necessary for processing in the job control unit 702.

The document management unit 900 includes one or more folder management units 901. The holder management unit 901 includes one or more job management units 902, or document management units 904. It holds a folder name (box name) set by the user. The job management unit 902 includes one or more binder management units 903. It can store/restore processing information held in the job management unit 811 of the job control unit. The processing information is information necessary for an operation of the job 814 processed by the job control unit 702.

The binder management unit 903 includes one or more document management units 904. It can store/restore processing information held by the binder management unit 812 in the job control unit. The processing information is information necessary for an operation of the binder 815 processed by the job control unit 802.

The document management unit 904 includes one or more page management units 905. It can store/restore processing information held by the document management unit 813 in the job control unit. The processing information is information necessary for an operation of the document 816 processed by the job control unit 702. Additionally, the document management unit 904 restores an attribute value of the input document 821 and stores an attribute value of the output document 822 processed by the document processing unit 820.

The page management unit 905 is associated with image data of one page recorded in the image storage unit 160 and read by the scanner, image data of one page having PDL sent from a host computer spread, image data of one page received through an FAX, or the like. It restores an attribute value of the input page 831 and stores an attribute value of the output page 832 processed by the page processing unit 830 in the job control unit 702.

As described above, it is possible to reproduce the job 814 entered during the image storage based on the information stored in the document management unit 900 and the image data stored in the image storage unit 160. It is also possible to perform an operation different from the entered job by resetting stored information.

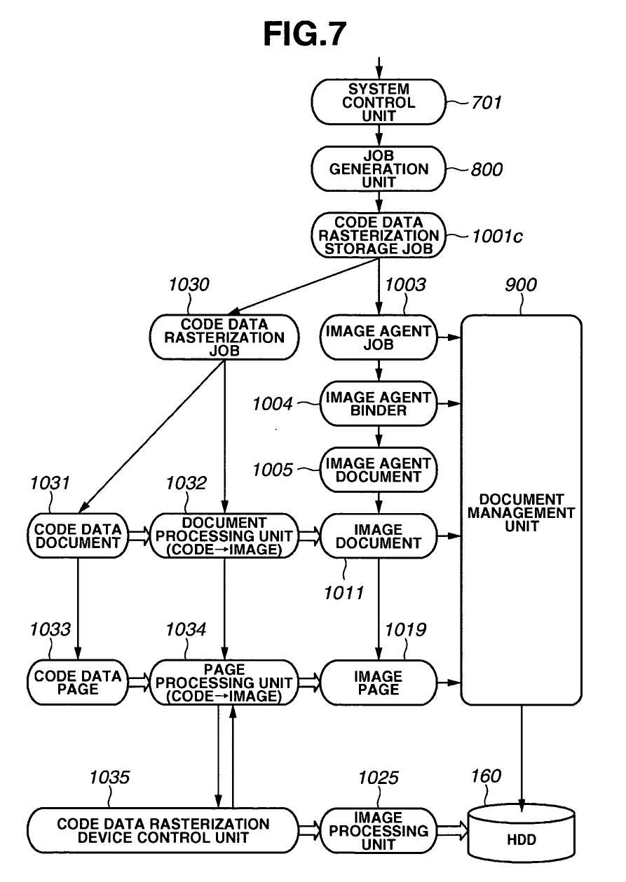

FIG. 7 shows an exemplary configuration of a code data rasterizing and storing job 1001c which is one of the jobs 814 executed by the controller 110 of FIG. 1. A series of operation requests sent from the client PC 601 or the operation unit 150 are sent in forms of command data through each interface. The command data that has been sent is interpreted by the system control unit 701 and sent to the job control unit 702. At this stage, the command is converted into a form to be understood by the job control unit 702. The job generation unit 800 interprets the received command to generate a code data rasterizing and storing job 1001c.

The code data rasterizing and storing job 1001c has a function of rasterizing code data passed from the system control unit 701 into image data that are stored in the image storage unit 160. The code data rasterizing and storing job 1001c generates a code data rasterizing job 1030 and an image agent job 1003. The image agent job 1003 generates an image agent binder 1004 of a unit that constitutes a job. The image agent binder 1004 generates an image agent document 1005 which is a unit constituting a binder.

The image agent document 1005 generates an image document 1011 which is an output document. The generated image document 1011 is transmitted via the image agent document 1005, the image agent binder 1004, the image agent job 1003, and the code data rasterizing and storing job 1001c to the code data rasterizing job 1030. The code data rasterizing job 1030 is included in the job processing unit 810, and setting and processing regarding the entire code data rasterizing job 1030, and setting and processing regarding the binder are executed. The code data rasterizing job 1030 first generates a code data document 1031 which is an input document, and then generates a document processing unit (code→image) 1032. Subsequently, the document processing unit 1032 is notified of the code data document 1031 which is an input document and the image document 1011 which is an output document in order to control the document processing unit (code→image) 1032.

The code data document 1031 which is the input document of code data development processing is converted into an image document 1011 which is an output document by the document processing unit (code→image) 1032. The document processing unit (code→image) 1032 executes only processing of a document unit, and more meticulous work is carried out in a code data page 1033, a page processing unit (code→image) 1034, and an image page 1019 which are smaller work units. The code data document 1031 specifies code data rasterized into an image of one page from code data received via the code data rasterizing and storing job 1001c and the code data rasterizing job 1030, and generates a code data page 1033 corresponding to the code data of one page.

The code data page 1033 is converted into an image page 1019 by the page processing unit (code→image) 1034. The page processing unit (code→image) 1034 grasps a sequence for rasterizing the code data into an image, issues a control command prepared by the code data rasterizing control unit 1035 to execute image rasterizing processing, and converts the code data page 1033 into an image page 1019. The image page 1019 stores the rasterized image data in the image storage unit 160 through the image processing unit 1025 under conditions of an image storing mode or the like. The image processing unit 1025 executes resolution or code conversion.

The code data rasterizing device control unit 1035 is actually a program executed by the CPU 112. The device control unit 1035 receives code data of one page corresponding to the code data page 1033 through the page processing unit (code→image) 1034, and interprets the data, for example, as page descriptive language (PDL) data depending on a type of the code data. The device control unit 1035 executes rasterizing processing into raster-image data.

The document management unit 900 manages the image data stored in the image storage unit 160 by units of the folder management unit 901, the job management unit 902, the binder management unit 903, the document management unit 904, and the page management unit 905. The set (attribute) value used by the job management unit 811, the binder management unit 812, and the document management unit 813, the attribute value of the image document 1011 converted by the document processing unit (code→image) 1032, the attribute value of the image page 1019 converted by the page processing unit (code→image) 1034, and the like are stored in the image agent job 1013, the image agent binder 1014, the image document 1011, and the image page 1019.

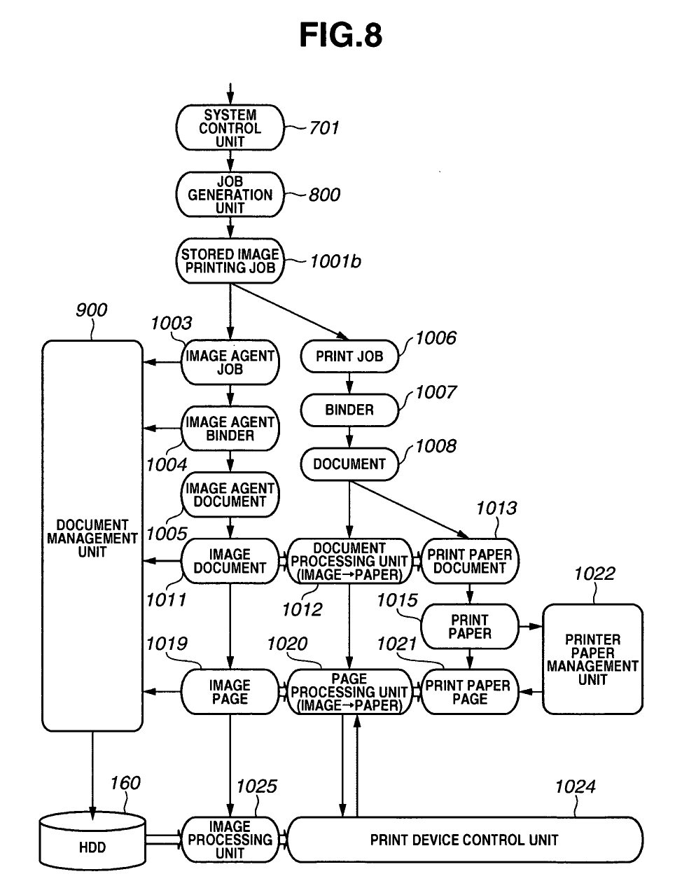

FIG. 8 shows an exemplary configuration of a stored image printing job which is one of the jobs 814 executed by the controller 110 of FIG. 1. A series of operation requests sent from the client PC 601 or the operation unit 150 are sent in forms of command data through each interface. The command data that has been sent is interpreted by the system control unit 701 and sent to the job control unit 702. At this stage, the command is converted into a form that can be understood by the job control unit 702.

The job generation unit 800 interprets the received command to generate a stored image printing job 1001b. The stored image printing job 1001b has a function of printing image data managed by the document management unit 900 shown in FIG. 6 and stored in the image storage unit 160, and generates an image agent job 1003 and a print job 1006. The image agent job 1003 generates an image agent binder 1004 of a unit that constitutes a job, and the image agent binder 1004 generates an image agent document 1005 which is a unit that constitutes a binder.

The image agent document 1005 generates an image document 1011 which is an input document. The generated image document 1011 is transmitted via the image agent document 1005, the image agent binder 1004, the image agent job 1003, and the stored image printing job 1001b to the print job 1006. The print job 1006 is divided into binders 1007 which are smaller work units, except setting and processing regarding the entire job, and into documents 1008 which are smaller work units, except setting processing regarding the entire binder. At this stage, the image document 1011 which is the input document is also transmitted.

The document 1008 that has received the image document 1011 as the input document first generates a printed paper document 1013 which is an output document, and then generates a document processing unit (image→paper) 1012. Subsequently, the document processing unit (image→paper) 1012 is notified of the image document 1011 which is an input document, and the printed paper document 1013 which is an output document to control the document processing unit (image→paper) 1012.

The image document 1011 which is the input document of print processing is converted into a printed paper document 1013 which is an output document, by the document processing unit (image→paper) 1012. The document processing unit (image→paper) 1012 executes only processing of a document unit, and more meticulous work is carried out in an image page 1019, a page processing unit (image→paper) 1020, and a printed paper page 1021 which are smaller work units. The printed paper document 1013 generates printed paper 1015 corresponding to each page of a sheet to actually output an image. The generated printed paper 1015 is registered by adding an identifier thereto in a printed paper management unit 1022 that controls output processing order and a printed paper page 1021 is generated.

The printed paper management unit 1022 decides processing order of the printed paper page 1021 based on specifications of an identifier added to the printed paper 1015, printing setting and a device. For example, processing order of the both-surface printing of the printer 300 described above with reference to FIG. 2 is decided based on the number of sheets circulating through the device and printing setting of both-surface recording.

The image page 1019 is converted into a printed paper page 1021 by the page processing unit (image→paper) 1020. The page processing unit (image→paper) 1020 grasps a sequence for controlling an actual printer device, issues an engine control command prepared by the printer device control unit 1024 to execute a printing operation, and converts the image page 1019 into a printed paper page 1021. The image page 1019 takes out the image data stored/managed in the document management unit 900 from the image storage unit 160 through the image processing unit 1025 based on printing setting or the like. The image processing unit 1025 executes resolution or code conversion in addition to image synthesis.

The document management unit 900 manages the image data stored in the image storage unit 160 by units of the folder management unit 901, the job management unit 902, the binder management unit 903, the document management unit 904, and the page management unit 905, and attributes at the time of image storing are stored therein. The designated image data is specified by the image agent job 1013, the image agent binder 1014, the image document 1011, and the image page 1019, and is taken out together with attributes values from the image storage unit 160.

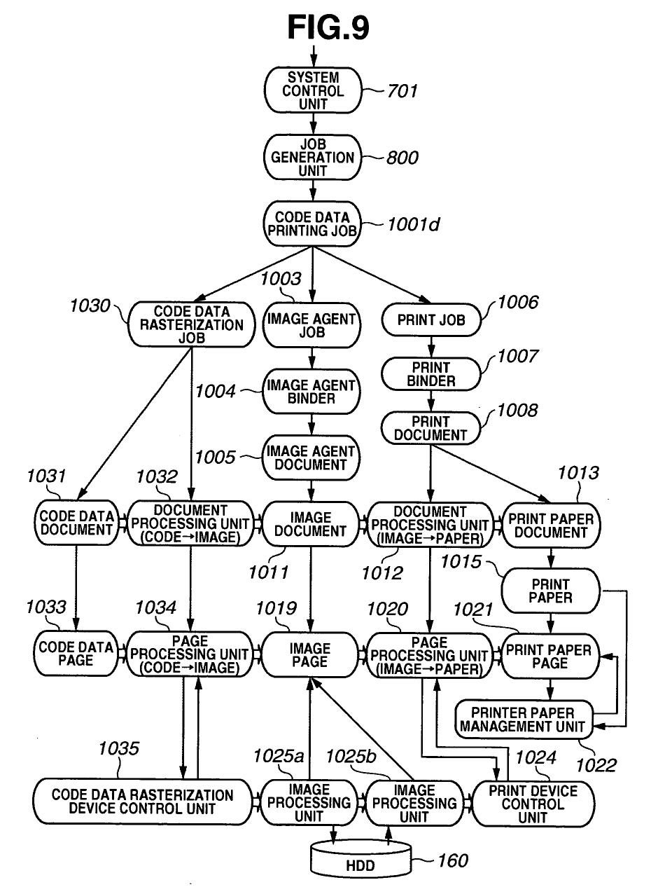

FIG. 9 shows an exemplary configuration of the code data printing job 1001d which is one of the jobs 814 executed by the controller 110 of FIG. 1. As in the case of the code data rasterizing and storing job, and the stored image printing job, when a command is sent to the job generation unit 800, the job generation unit 800 interprets the command. The job generation unit 800 generates a code data printing job 1001d and requests controlling. Portions similar to those of FIGS. 7 and 8 are denoted by similar reference numerals. The image processing unit 1025 includes image processing units 1025a and 1025b. The code data printing job 1001d has a function of rasterizing code data passed from the system control unit 701 into an image and printing the code data. The code data printing job 1001d generates and controls a code data rasterizing job 1030, an image agent job 1003, and a print job 1006.

The image agent job 1003 generates an image agent binder 1004 of a unit that constitutes a job. The image agent binder 1004 generates and controls an image agent document 1005 which is a unit constituting a binder. The image agent document 1005 is an output document of the code data rasterizing job 1030, and an image document 1011 that is an input document of the print job 1006 is generated and controlled. The generated image document 1011 is transmitted through the image agent document 1005, the image agent binder 1004, the image agent job 1003, and the code data printing job 1001d to the code data rasterizing job 1030 and the print job 1006.

Operations under the code data rasterizing job 1030 and the print job 1006 are similar to those described above with reference to FIGS. 7 and 8. However, a different feature from the code data rasterizing and storing job and the stored image printing job is as follows. In the case of the image agent job 1003, the image agent binder 1004, the image document 1011, and the image page 1019, respectively managed attributes are not stored/read in/from the document management unit 900.

The image storage unit 160 is used so that the image page 1019 can temporarily spool the image data. However, since the attribute is not stored in the document management unit 900, the image data generated by the code data printing job cannot be printed by the stored image printing job.

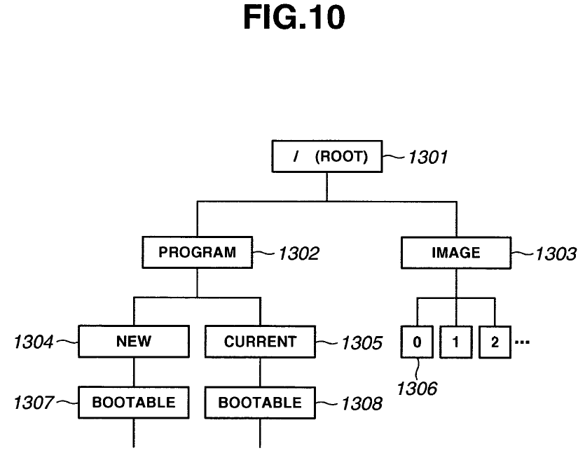

Next, referring to FIGS. 10 to 13, update processing of various control programs executed at the time of starting the digital multi-function peripheral 100 of FIG. 1 will be described.

FIG. 10 shows an exemplary directory structure built by using a file system of the HDD 162 shown in FIG. 3. In this case, the file system may be a general MS-DOS FAT file system or another file system. In the file system of the HDD 162, a directory PROGRAM 1302 and a directory IMAGE 1303 are present immediately below a route 1301 that is located highest in the directory structure. A plurality of files 1306 for storing image data are created below the directory IMAGE 1303. A directory NEW 1304 and a directory CURRENT 1305 are present below the directory PROGRAM 1302. In the description below, a break point of the directories may be represented by using “/”.

Below the directory CURRENT 1305, a file BOOTABLE 1308 for storing a control program that is normally loaded to the DRAM 116 and executed, is present. Below the directory NEW 1304, a file BOOTABLE 1307 is created when an updating control program transferred from the outside is received. For example, by the FTP server function or the like of the system control unit 701, a file of this updating control program is received from the client PC 601 through the network and stored in the BOOTABLE 1307.

A destination to which the control program is transferred is not limited to the client PC 601, but it may be another server or a network attached storage (NAS) having a network communication function on the network. When the digital multi-function peripheral 100 includes a local interface such as a universal serial bus (USB) in addition to the network, the updating control program may be transferred through the USB. In this case, the updating control program may be transferred from a USB memory or a notebook PC. When the digital multi-function peripheral 100 includes a radio LAN interface such as IEEE 802.11a, b, g or a radio interface such as Bluetooth, the updating control program may be transferred via communication using such a radio interface. When the updating control program is received by downloading during the operation of the digital multi-function peripheral 100, the reception of the updating control program may be displayed by the operation unit 150.

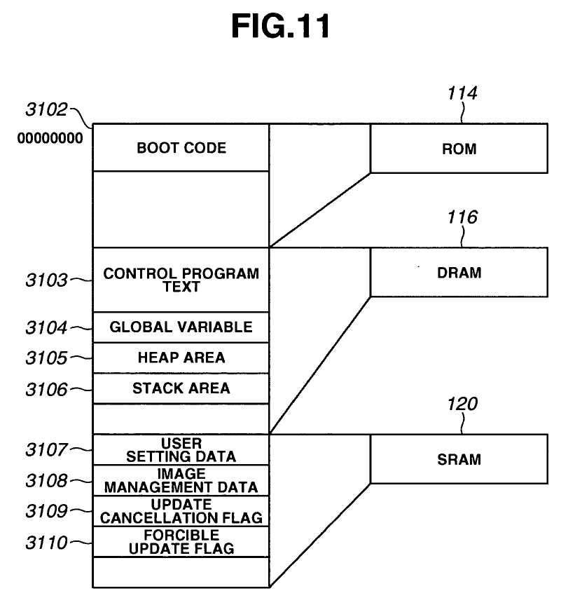

FIG. 11 shows an example of a memory map for the CPU 112 shown in FIG. 3, and portions similar to those of FIG. 3 are denoted by similar reference numerals. When the system is started, a reset signal is input to the CPU 112. A boot code 3102 stored in the ROM 114 is mapped in an address that is first executed by the CPU 112.

An area where the DRAM 116 is mapped is assigned to a text (code) 3103 of the control program, a global variable 3104 of the control program, a heap 3105 of the control program, a stack 3106 of the control program, or the like.

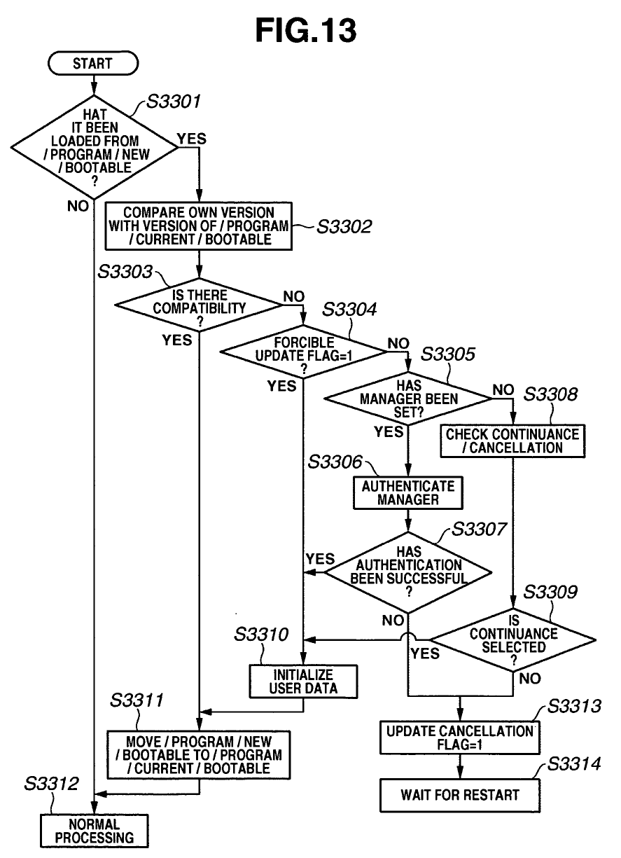

An area where the SRAM 120 is mapped is assigned to set data 3107 of the user, management data 3108 of the image data, an update cancellation flag 3109, a forcible update flag 3110, or the like. If the update cancellation flag 3109 is set to “1” in step S3314 shown in FIG. 13 described below, when the updated control program is started, the update cancellation flag 3109 is referred to. Accordingly, it is possible to prevent rewriting of the user set data 3107 or the like. Similarly, when the forcible update flag 3110 is set to “1” in the step S3314 of FIG. 13, the user set data 3107 stored in the SRAM 120 is forcibly initialized at the time of restarting the control program updated during the operation of the control program.

The user set data (user data hereinafter) is a value input from the operation unit 150 by the user, which includes a value preferred by the user and used as a default value of job processing in the digital multi-function peripheral 100, such as turning ON/OFF of both-surface printing, a preferential feeding cassette, or a paper ejection pin for each job type. The user data 3107 is carelessly rewritten and the data is forcibly rewritten to contents or the like set as a default at the time of restarting the updating control program, for example, if the control program is updated during the operation of the control program.

Thus, a user who desires an operation in the same environment must set user data again, which increases an operation load on the user. An environment in which the user data 3107 is set meticulously in detail results in a forcible operation of the same setting on the user. The exemplary embodiment is advantageous for the image processing apparatus in that the user can select whether updating of the control program is executed before the user data is rewritten by updating the control program.

Additionally, the image management data 3108 corresponds to an image storing file created below the directory IMAGE 303, and contains attribute information and management information of the image data such as storing time, a job type, and a user name of the image data. The image management data 3108 is created and managed by the document management unit 900. There is a risk that contents of the image management data 3108 may be rewritten depending on the updating control program at the time of updating the control program. The user data 3107 and the image management data 3108 are both pieces of set information of the image processing apparatus. Hereinafter, the user data 3107 and the image management data 3108 may be generically referred to as “user data or the like”.

The update cancellation flag 3109 and the forcible update flag 3110 are control flags referred to by the CPU 112 in processing at the time of starting the system as described below with reference to FIG. 13. The forcible update flag 3109 can be turned ON/OFF only by a specific user, e.g., a manager of the digital multi-function peripheral 100.

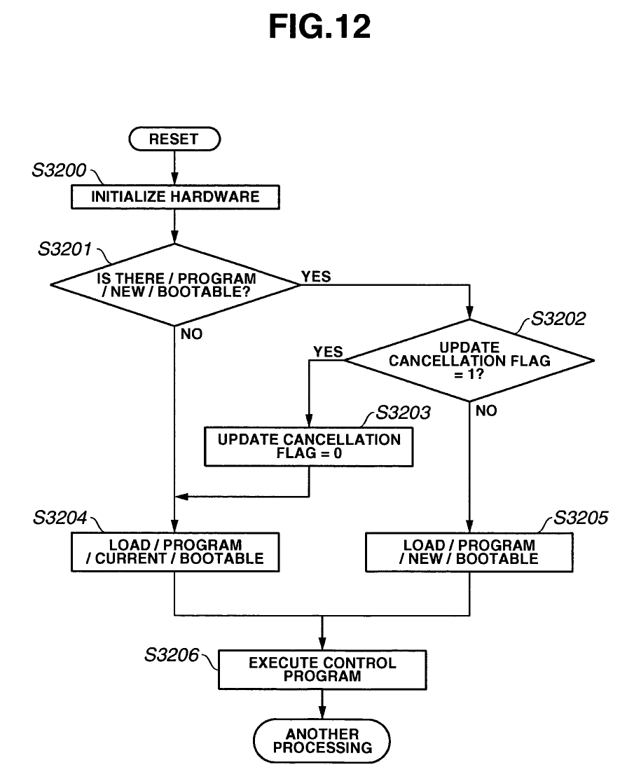

FIG. 12 is a flowchart showing an example of a first data processing procedure in the image processing apparatus (digital multi-function peripheral 100) of the exemplary embodiment, which corresponds to a program update processing procedure executed by the CPU 112 at the time of starting the apparatus such as the time of turning ON power for the image processing apparatus (digital multi-function peripheral 100). S3200 to S3206 are steps, and each step is realized when the CPU 112 executes a boot code 3102.

First, when the CPU 112 is reset to start the boot code 3102, hardware necessary for loading and executing a control program 700 is initialized (S3200). Next, a route is searched to investigate presence of /PROGRAM/NEW/BOOTABLE 1307 in the file system (S3201). When the BOOTABLE 1307 is determined to be absent, tracing is executed from the file system to /PROGRAM/CURRENT/BOOTABLE 1308 that is loaded on an area of a control program text 3103 which is to be executed (S3204).

On the other hand, when tracing is executed to /PROGRAM/NEW/BOOTABLE 1307, and the /BOOTABLE 1307 is determined to be present in the step S3201, it is checked whether switching processing of the control program was cancelled at the previous starting time of the digital multi-function peripheral 100, i.e., whether the update cancellation flag 3109 stored in the SRAM 120 is “1” or not (S3202).

According to the exemplary embodiment, when the switching of the control program is canceled, the update cancellation flag 3109 is set to “1” as described below. Thus, when the update cancellation flag is “1”, the update cancellation flag is set to “0” to execute the switching processing of the control program again at next starting time (S3203), and tracing is executed to the /PROGRAM/CURRENT/BOOTABLE 1308 to load the /BOOTABLE 1308 (S3204). In other words, the control program before updating is loaded.

On the other hand, when the update cancellation flag 3109 is determined to be “0” in the step S3202, tracing is executed from the file system to the /PROGRAM/NEW/BOOTABLE 1307 and the /BOOTABLE 1307 is loaded on the area of the control program text 3103 (S3205). In other words, the updating control program is loaded.

Then, when the control program is loaded on the control program text 3103 in the step S3204 or the step S3205, the process jumps to its start address, and the control program is started (S3206). Then, the process proceeds to another step. When the /PROGRAM/CURRENT/BOOTABLE 1308 before updating is executed while the /PROGRAM/NEW/BOOTABLE 1307 i.e. the updating control program, is present in the file system, it may be displayed by the operation unit 150 that the control program before updating is being executed although the updating control program is being downloaded.

FIG. 13 is a flowchart showing an example of a second data processing procedure in the image processing apparatus of the exemplary embodiment. The flowchart shows processing at the time of starting the system which is executed after the execution of the flowchart of FIG. 12 is completed. This processing corresponds to the program update processing executed by the CPU 112. S3300 to S3314 are steps, and each step is realized when the CPU 112 executes the boot code 3102.

When the control program 700 is started from the boot code 3102, the control program 700 first investigates from which the boot code has been loaded or whether it has been loaded from the directory /PROGRAM/NEW/BOOTABLE 1308 in the HDD 162 based on a file name or a flag stored in a predetermined position in the DRAM 116 (S3301). Then, tracing is executed to the directory /PROGRAM/CURRENT/BOOTABLE 1308 in the HDD 162. When it is determined that the loading is executed from the /BOOTABLE 1308 (NO), normal processing is started (S3312).

On the other hand, when it is determined that loading is executed from the directory /PROGRAM/NEW/BOOTABLE 1307 in the HDD 162 in the step S3301, the process proceeds to step S3302 to start switching processing of the control program. In the step 3302, pieces of version information are read from the /PROGRAM/NEW/BOOTABLE 1307 and the /PROGRAM/CURRENT/BOOTABLE 1308 which are compared with each other. Then it is determined whether there is compatibility between the user data 3107 stored in the SRAM 120 and a format of the image management data 3108 (S3303).

If there is compatibility, the /PROGRAM/NEW/BOOTABLE 1307 can be started without deleting the user data 3107 or the image management data 3108. On the other hand, if there is no compatibility, the starting of the /PROGRAM/NEW/BOOTABLE 1307 results in loss of the user set data and the image management data. When compatibility is determined to be present in the step S3303, the user set data 3107 and the image management data 3108 can be used as they are. Accordingly, in step S3311, the /PROGRAM/NEW/BOOTABLE 1307 is moved to the /PROGRAM/CURRENT/BOOTABLE 1308 to start normal processing (S3312). In the processing of the step 3311, the updating of the control program is completed.

On the other hand, when it is determined that there is no compatibility in the step S3303, in a step S3304, it is checked whether a value of the forcible update flag 3110 stored in the SRAM 120 is “1” or not. The value of the forcible update flag 3110 can be set from the operation unit 150 by a specific user such as a manager, and it is normally set during the system operation. When back-up of the user data or the like has been completed by manager's operation, and the updating of the user data by the updating control program is permitted, the forcible update flag 3110 is used. Then, it is referred to when the step S3304 is being executed during the system operation.

If a value of the forcible update flag 3110 is “1”, the control program can be updated unconditionally. When it is determined that the value is “1” in the step S3304, in step S3310, the data 3107 and the image management data 3108 set by the user are initialized, and then update processing of the control program is executed in the step S3311 as described above to start a normal operation (S3312). Depending on the updating control program, there is no compatibility between the control program before updating and the user data 3107, however, there can be compatibility with the image management data 3108. Alternatively, there can be compatibility with the user data 3107 while there is no compatibility with the image management data 3108. In the step S3310, only the data that has no compatibility may be initialized between the user data 3107 and the image management data 3108.

Then, by the processing of the step S3310, the user data 3107 and the image management data 3108 are initialized. Before the user data or the like is initialized in the step S3310, data deleted from the SRAM 120 by the initializing may be backed up in a predetermined area of the HDD 162 or the like.

On the other hand, if the forcible update flag 3110 is determined to be “0”, in the step S3305, setting of a manager password in the SRAM 120 is investigated. If it is determined that the setting is performed, the user inputs a manager password from the operation unit 150 that is authenticated with the manager password set in the SRAM 120 (S3306), and it is determined whether the authentication is successful (S3307). If the passwords coincide with each other, the update processing of the control program is continued, and the steps S3310, S3311, and S3315 are executed as described above. In other words, updating of the control program that initializes the user data is inhibited when a general user starts the digital multi-function peripheral 100. The inhibition is released when the manager starts the digital multi-function peripheral 100. Accordingly, it is possible to prevent loss of the user data or the like even when the digital multi-function peripheral 100 downloads the updating control program that brings about initialization of the user data 3107, during the previous operation, and a general user executes next starting.

Furthermore, if it is determined that a manager password is set in the step S3305, the user selects continuance/cancellation of the update processing of the control program (S3308). In this case, the operation unit 150 may inquire the user about selection permission, and the user data 3107 or the image management data 3108 to be deleted by the updating of the control program may be displayed in a list form by the operation unit 150 and referred to. Control may be executed in such a manner that information such as the user data deleted by the initialization of the step S3310 is temporarily stored in another storage area and, after the start of the updating control program, the user data stored as new user data is overwritten and restored. In this case, selection and designation of data permitted to be deleted and data inhibited to be deleted among the user data or the like are convenient and useful for the user.

Then, determination is made as to selection of continuance (S3309). If the continuance is determined to be selected, the update processing of the control program is continued, and the steps S3310, S3311, and S3312 are executed as described above. If it is determined that the collation of the manager password is a failure in the step S3307, or if it is determined that the user selects cancellation of the update processing of the control program in the step S3309, the update cancellation flag 3109 of the SRAM 120 is set to “1” (S3313) to wait for a restart of the system (S3314).

As described above, the update cancellation flag 3309 is referred to by the boot code at next starting time of the system, and set to “0” after it has been referred to.

Thus, even when the updating control program is downloaded during the execution based on the control program, depending on a selection whether the user data which has been set and registered should be deleted, it can be determined whether the updating control program is executed as a control program. Accordingly, it is possible to prevent careless loss of the user data or the like.

As described above, according to the exemplary embodiment, the updating control program can be downloaded during the operation of the digital multi-function peripheral 100. At the time of restarting after downloading, when the updating control program is started to update the control program of the digital multi-function peripheral 100, even if an apparatus that has downloaded the updating control program without back up of the user data 3107 or the image management data 3108 is restarted to perform version upgrading, the version upgrading can be canceled before loss of the user set data 3107 or the image management data 3108 and the loss can be prevented.

### Second Exemplary Embodiment

The case where forcible loss of the user set data 3107 such as the turning ON/OFF of both-surface printing, the preferential feeding cassette, or the job type from the set state of one flag is prevented has been described above. However, when plural pieces of user set information can be set corresponding to function settings, each user set information may be retrieved to execute permission as to loss of each information.

### Third Exemplary Embodiment

The exemplary embodiment has been described in which the entire control program 700 is updated during its starting. However, the present invention can be applied to a case where one of modules is updated in which programs that should be updated are plural modules, depending on a program structure. The invention can also be applied to a case where firmware is updated.

### Fourth Exemplary Embodiment

The exemplary embodiment has been described in which the entire control program 700 is updated during its starting process. However, control may be executed in such a manner that, even if the updating control program has been downloaded, version upgrading is not started when the digital multi-function peripheral 100 is started from a power-saving mode.

### Fifth Exemplary Embodiment

The exemplary embodiment has been described in which the manager authentication (step S3306) or the checking processing (step S3308) is executed when the entire control program 700 is updated during its starting. However, a forcible version upgrading mode in which the manager authentication or the checking processing is not executed may be provided, and a flag indicating the forcible version upgrading mode may be stored. Thus, when the processing of FIG. 13 is executed during version upgrading, if the flag indicating the forcible version upgrading mode is set to “1” that permits execution, a step corresponding to the authentication processing or the checking processing of FIG. 13 is omitted, and interruption with the version upgrading processing is prevented. Therefore, the version upgrading processing is completed quickly.

### Sixth Exemplary Embodiment

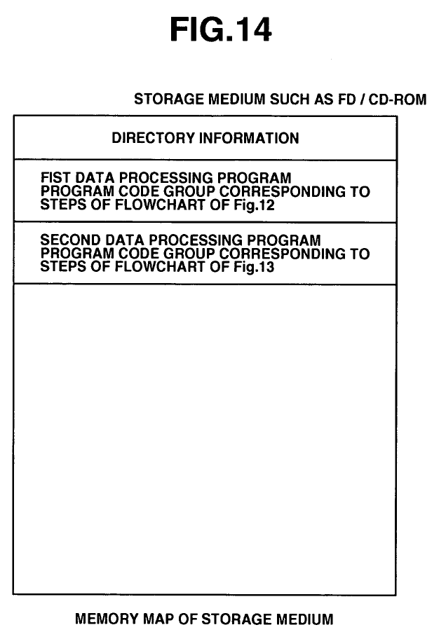

Referring to a memory map of FIG. 14, an exemplary structure of a data processing program read by the printer of the present invention will be described below. FIG. 14 shows a memory map of a storage medium for storing various data processing programs read by the printer of the present invention.

### Other Exemplary Embodiments, Features and Aspects of the Present Invention

Though not shown, information for managing a group of programs stored in the storage medium, such as version information or a creator, may be stored. Information dependent on an OS or the like on a program reading side, such as an icon identifying and indicating a program, may also be stored.

Data subordinate to various programs are managed in the directory. When a program for installing various programs in a computer or a program to be installed is compressed, a program for decompression may be stored.

According to the exemplary embodiment, the functions shown in FIGS. 12 and 13 may be executed by the host computer based on a program installed from the outside. In this case, the invention can be applied even when an information group including a program is supplied to the output device from a storage medium such as a CD-ROM, a flash memory or an FD, or the outside storage medium through the network.

As described above, the object of the present invention can be achieved by supplying the storage medium storing the program code of the software that realizes the functions of the exemplary embodiment, to the system or the apparatus, and reading and executing the program code stored in the storage medium by the computer (or CPU, MPU) of the system or the apparatus. In this case, the program code itself read from the storage medium realizes a new function of the invention, and the storage medium storing the program code constitutes the invention. Thus, as long as the program functions are present, any forms of programs such as programs executed by an object code or an interpreter, script data or the like supplied to the OS can be employed.

As the storage medium for supplying the program, for example, a flexible disk, a hard disk, an optical disk, a magneto-optical disk, a CD-ROM (compact disk—read-only memory), a CD-R (CD—recordable), a CD-RW (CD—rewritable), a magnetic tape, a nonvolatile memory card, an ROM, or a DVD (digital versatile disk) can be used. In this case, the program code itself read from the storage medium realizes the functions of the exemplary embodiment, and the storage medium storing the program code constitutes the invention.

As a program supplying method, the program can be supplied by connecting to a homepage of Internet through a browser of the client computer, and downloading the computer program itself or a compressed file including an automatic installing function onto a recording medium such as a hard disk from the homepage. The program can also be supplied by dividing the program code constituting the program of the invention into a plurality of files and downloading each file from the homepage. In other words, a WWW (World Wide Web) server, an ftp server or the like for allowing a plurality of users to download the program files for realizing the function and processing of the present invention by the computer is included in claims of the invention.

The program can be supplied by encrypting the program of the invention to store it in a storage medium such as a CD-ROM, distributing it to the user, allowing a user who satisfies predetermined conditions to download key information for decryption from the homepage through the Internet, and executing the encrypted program by using the key information to install it in the computer.

Needless to say, not only the functions of the exemplary embodiment is realized by executing the program code read by the computer but also the operating system (OS) or the like running on the computer executes a part or all of actual processing, and the functions of the exemplary embodiment are realized by the processing according to the present invention.

Furthermore, the program code read from the storage medium may be written in the function expansion board inserted into the computer or the memory disposed in the function expansion unit connected to the computer, then the CPU or the like disposed in the function expansion board or the function expansion unit executes a part or all of actual processing, and the functions of the exemplary embodiment are realized by the processing according to the present invention.

The present invention is not limited to the exemplary embodiments, various modifications (including organic combinations of the embodiments) can be made based on the teachings of the invention, and these are not outside the scope of the invention. The present invention is advantageous in that even when the apparatus having the updating control program downloaded without back-up of the user data or the image management data is restarted to perform version upgrading, loss of the user data can be prevented by canceling the version upgrading before the user data or the image management data is deleted. The preferred exemplary embodiments of the present invention have been described. However, the invention is not limited to the exemplary embodiments, but various changes and modifications can be made within the scope of the claims.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2005-116538 filed Apr. 14, 2005, which is hereby incorporated by reference herein in its entirety.

What is claimed is:

1. An image processing apparatus for performing an image processing operation based on execution of a control program, comprising:
a receiving unit configured to receive an updating control program;
an updating unit configured to update the control program to the updating control program; and
a control unit configured to inhibit the updating unit from updating the control program to the updating control program when it is determined that the updating of the control program to the updating control program by the updating unit causes loss of set information of the image processing apparatus referred to by the control program.

2. The image processing apparatus according to claim 1, wherein the control unit permits the updating unit to update the control program to the updating control program when it is determined that the updating of the control program to the updating control program by the updating unit causes no loss of the set information of the image processing apparatus referred to by the control program.

3. The image processing apparatus according to claim 1, further comprising an authenticating unit configured to authenticate a manager capable of instructing the updating unit to update the control program to the updating control program,
wherein the control unit permits the updating unit to update the control program to the updating control program when the updating of the control program to the updating control program by the updating unit causes loss of the set information of the image processing apparatus referred to by the control program, and when the manager authentication by the authenticating unit is successful.

4. The image processing apparatus according to claim 1, further comprising a storing unit configured to store the updating control program received by the receiving unit,
wherein the storing unit stores and manages the updating control program received by the receiving unit and the control program as identifiable files.

5. The image processing apparatus according to claim 4, wherein the updating unit updates the control program to the updating control program during a start of the image processing apparatus after the storing unit stores the updating control program received by the receiving unit.

6. The image processing apparatus according to claim 4, wherein the updating unit updates the control program to the updating control program by overwriting the control program stored in the storing unit with the updating control program.

7. An image processing apparatus for performing an image processing operation based on execution of a control program, comprising:
a storing unit configured to store an updating control program received from outside the apparatus;
a determining unit configured to determine whether loss of set information of the image processing apparatus referred to by the control program is caused by updating of a control program to the updating control program stored in the storing unit; and
a deciding unit configured to decide whether to update the control program to the updating control program stored in the storing unit based on determination of the determining unit.

8. An image processing apparatus for performing an image processing operation based on execution of a control program, comprising:
a storing unit configured to store the control program and an updating control program;
a determining unit configured to determine whether loss of set information of the image processing apparatus referred to by the control program is caused by updating of the control program to the updating control program; and
a selecting unit configured to selectively execute one of the control program and the updating control program based on a determining result of the determining unit when the updating control program is stored in the storing unit.

9. The image processing apparatus according to claim 8, wherein the selecting unit executes the control program when the determining unit determines that the loss of the set information of the image processing apparatus referred to by the control program is caused by the updating of the control program to the updating control program.

10. The image processing apparatus according to claim 8, wherein the selecting unit executes the updating control program when the determining unit determines that the loss of the set information of the image processing apparatus referred to by the control program is not caused by the updating of the control program to the updating control program.

11. The image processing apparatus according to claim 8, wherein the determining unit determines whether the loss of the set information of the image processing apparatus referred to by the control program is caused by the updating of the control program to the updating control program depending on presence of compatibility between the set information of the image processing apparatus referred to by the control program and set information of the image processing apparatus referred to by the updating control program.

12. The image processing apparatus according to claim 8, wherein a flag of the updating control program indicating cancellation of updating is set when the determining unit determines the loss of the set information of the image processing apparatus referred to by the control program is caused by the updating of the control program to the updating control program.

13. The image processing apparatus according to claim 12, wherein the flag indicating the cancellation of the updating is reset when the selecting unit executes the control program from the storing unit.

14. A method for updating a control program in an image processing apparatus for performing an image processing operation based on execution of the control program, comprising:
a receiving step of receiving an updating control program;
an updating step of updating the control program to the updating control program; and
a control step of inhibiting the updating step from updating the control program to the updating control program when it is determined that the updating of the control program to the updating control program in the updating step causes loss of set information of the image processing apparatus referred to by the control program.

15. A method for updating a control program in an image processing apparatus for performing an image processing operation based on execution of the control program, comprising:
a storing step of storing an updating control program received from the outside in a storing unit;
a determining step of determining whether loss of set information of the image processing apparatus referred to by the control program is caused by updating of the control program to the updating control program stored in the storing unit; and
a deciding step of deciding whether to update the control program to the updating control program stored in the storing unit based on a determining result of the determining step.

16. A method for updating a control program in an image processing apparatus which includes a storing unit configured to store the control program and an updating control program and performs an image processing operation based on execution of the control program, comprising:
a determining step of determining whether loss of set information of the image processing apparatus referred to by the control program is caused by updating of the control program to the updating control program; and
a selecting step of selectively executing one of the control program and the updating control program based on a determining result of the determining step when the updating control program is stored in the storing unit.

17. A program for causing an image processing apparatus to execute a method for updating a control program in the image processing apparatus for performing an image processing operation based on execution of the control program, comprising:
a receiving module configured to receive an updating control program;
an updating module configured to update the control program to the updating control program; and
a control module configured to inhibit the updating module from updating the control program to the updating control program when it is determined that the updating of the control program to the updating control program by the updating module causes loss of set information of the image processing apparatus referred to by the control program.

18. A program for causing an image processing apparatus to execute a method for updating a control program in the image processing apparatus for performing an image processing operation based on execution of the control program, comprising:
a storing module configured to store an updating control program received from the outside in a storing unit;
a determining unit configured to determine whether loss of set information of the image processing apparatus referred to by the control program is caused by updating of the control program to the updating control program stored in the storing unit; and
a deciding module configured to decide whether to update the control program to the updating control program stored in the storing unit based on a determining result of the determining module.

19. A program for causing an image processing apparatus to execute a method for updating a control program in the image processing apparatus which includes a storing unit capable of storing the control program and an updating control program and performs an image processing operation based on execution of the control program, comprising:
a determining module configured to determine whether loss of set information of the image processing apparatus referred to by the control program is caused by updating of the control program to the updating control program; and
a selecting module configured to selectively execute one of the control program and the updating control program based on a determining result of the determining module when the updating control program is stored in the storing unit.
